(19) United States
(12) Patent Application Publication
(10) Pub. No.: US 2003/0111648 A1
(43) Pub. Date: Jun. 19, 2003

(54) Conductive composition exhibiting PTC behavior

(76) Inventors: Edward Fu-Hua Chu, Taipei (TW); David Shau-Chew Wang, Taipei (TW); Yun-Ching Ma, Taipei Hsien (TW)

Correspondence Address: Harold V. Stotland, Seyfarth Shaw, 42nd Floor, 55 East Monroe Street, Chicago, IL, 60603-5803, US

(21) Appl. No.: 10/082,638

(22) Filed: Feb. 25, 2002

(30) Foreign Application Priority Data
Sep. 26, 2001 (TW) 090123769

(51) Int. Cl. H01B 1/02; H01C 1/00; H01B 1/12; C08L 1/00; H01B 1/06

(52) U.S. Cl. 252/511; 252/513; 252/514; 252/519.32

(57) ABSTRACT

The present invention discloses a conductive composition, comprising: (a) at least one polymer; (b) at least one conductive filler, dispersed in the polymer; and (c) a coupling agent, applied to improved the adhesion between the polymer and the conductive filler and having a structure as follows:

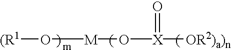

wherein M represents a metal atom or silicon; R¹ and R² represent a substituted or unsubstituted alkyl group; X represents sulfur or phosphorous; and a, m and n represent integers of 0 to 2.

### BACKGROUND OF THE INVENTION

1. Field of the Invention

The present invention relates to a conductive composition exhibiting Positive Temperature Coefficient (PTC) behavior, and more particularly, to a conductive composition exhibiting PTC behavior which can be applied to an over-current protection device.

2. Description of the Prior Art

The conductive composition exhibiting PTC behavior acts as a to current-sensitive element due to its sensitivity to temperature. Therefore, the PTC conductive composition has been widely applied to the over-current protection device for protecting batteries or circuit elements. The resistance of the PTC conductive composition is very low at normal temperature so that the circuit elements or the batteries can operate normally. However, if an over-current or an over-temperature situation occurs, the resistance of the PTC conductive composition will immediately increase at least ten thousand times (over 10⁴ ohm) to a high resistance state. Therefore, the over-current will be counterchecked and the objective to protect the circuit elements or batteries is achieved.

Generally, the PTC conductive composition is composed of at least one crystalline polymer and a conductive filler well dispersed in the polymer. The polymer is a polyolefin such as polyethylene. The conductive filler is carbon black, metal powder or non-oxygen ceramic powder such as titanium carbide (TiC) or tungsten carbide (WC).

The conductivity of the conductive composition depends on the category or content of the conductive filler. Generally, the carbon black has better adhesion with the polyolefin because of its rough surface. Therefore, the PTC conductive composition with carbon black has better resistance reproductivity. On the other hand, the conductivity provided by the carbon black is smaller than that provided by metal powder or the non-oxygen ceramic powder. The specific gravity of the metal powder is greater than that of carbon black; therefore the metal powder cannot be dispersed well and easy to be oxidized. To decrease the resistance of the over-current protection device and avoid being oxidized, the conductive filler of the conductive composition tends to use the non-oxygen ceramic powder. Unlike the carbon black, the non-oxygen ceramic powder does not have the rough surface, and the adhesivity of the ceramic powder to the polyolefin is less than that of carbon black. Therefore, the resistance reproductivity of the conductive composition with non-oxygen ceramic powder is difficult to be controlled. To improve the adhesion between the ceramic powder and polyolefin, the conventional conductive composition with the ceramic powder further comprises a coupling agent, such as anhydride or silane. However, the coupling agent cannot effectively decrease the entire resistance of the conductive composition.

For this reason, the present invention discloses a conductive composition exhibiting PTC behavior, which can not only enhance the adhesion between the polymer, conductive filler and electrodes to improve its resistance reproductivity, but also increase the cycle life and voltage endurance when it is applied to the over-current protection device.

### SUMMARY OF THE INVENTION

A major objective of the present invention is to provide a conductive composition with positive temperature coefficient (PTC) behavior, which can enhance the adhesion between the polymer and the conductive filler and improve the resistance reproductivity, so that the volume resistivity will not be influenced.

Another objective of the present invention is to provide a conductive composition with positive temperature coefficient (PTC) behavior, which can improve the cycle life and the voltage endurance time of the device when it is applied to the over-current protecting device of the battery or the circuit element.

In order to achieve the above objectives and to avoid the disadvantages of the prior art, the present invention discloses a conductive composition, comprising:

(a) at least one polymer;

(b) at least one conductive filler, dispersed in the polymer; and

(c) a coupling agent, applied to improve the adhesion between the polymer and the conductive filler and having a structure as follows:

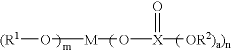

wherein M represents a metal atom or silicon; R¹ and R² represent a substituted or unsubstituted alkyl group; X represents sulfur or phosphorous; a, m and n represent integers of 0 to 2.

The foregoing and other objectives and advantages of the invention and the manner in which the same are accomplished will become clearer based on the following detailed description in conjunction with the accompanying drawings.

### DETAILED DESCRIPTION OF THE INVENTION

In order to achieve the above objectives and to avoid the disadvantages of the prior art, the present invention discloses a conductive composition, comprising:

(a) at least one polymer;

(b) at least one conductive filler, dispersed in the polymer; and

(c) a coupling agent, applied to improve the adhesion between the polymer and the conductive filler and having a structure as follows:

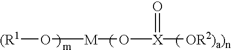

wherein M represents a metal atom or silicon; R¹ and R² represent a substituted or unsubstituted alkyl group; X represents sulfur or phosphorous; and a, m and n represent integers 0 to 2.

The polymer of the component (a) is a crystalline or non-crystalline polymer, which is selected from the group consisting of epoxy resin, polyethylene, polypropylene, polyoctylene and its copolymer or the mixture thereof. The volume percentage of the polymer is from approximately 20% through 80%, preferably from approximately 30% through 70%.

In component (b), the material of the conductive filler is carbon black, metal or ceramic powder. The conductive filler is selected from the group consisting of carbon black, nickel, silver, gold, graphite, titanium carbide, tungsten carbide and the mixture thereof and it is in grain, flake, fiber or powder form. The volume percentage of the conductive filler is from approximately 20% through 90%, preferably from approximately 30% through 70%.

The feature of the present invention is that the coupling agent of the component (c) is a complex, which can improve the adhesion between the conductive filler and the polymer because of its coordinate ligand. The volume percentage of the coupling agent is from approximately 0.05% through 5%, preferably from approximately 0.1% through 1%.

In the compound (c), the R¹, R², M, X, a, m and n have the same meaning as defined above. M is selected from the group consisting of titanium, zirconium, molybdenum, platinum, silicon, palladium and nickel. R¹ and R² are the same or different group, selected from a straight or branched alkyl group such as butyl, pentyl, octyl, decyl; and an alkenyl group such as butenyl, pentenyl, etc. If the R¹ and R² are a straight group, the polarity of the coupling agent is similar to the polymer, such as polyethylene, polypropylene and polyoctylene, etc. In this case, the mixed ability of the polymer and the conductive filler is improved and the adhesion is also enhanced.

Moreover, to improve the toughness and the strength, the conductive composition of the present invention further comprises a cross-linking agent, photo initiator, anti-oxidizing agent, stabilizer and non-conductive filler.

### EXAMPLE

The components used in the Examples and the Comparative Examples are as follow:

| Component | Commercial Name | Feature |
|---|---|---|
| High density | | melt index: 1.0 g/10 min; |
| polyethylene | | specific gravity: 0.96; |
| | | melting point: 129˜131° C. |
| | | (measured by differential |
| | | scanning calorimetry) |
| Titanium carbide | (CERAC) | particle size: 2 μm |
| Coupling agent 1 | KBM503 | boiling point: 255° C.; |
| (silane) | (shin_Etsu) | specific gravity: 1.04 |
| Coupling agent 2 | capow12 (kenrich) | Powder form; |
| (Zirconium complex) | | specific gravity: 1.29 |
| Coupling agent 3 | capow38 (kenrich) | Powder form; |
| (Zirconium complex) | | specific gravity: 1.30 |

### Example 1

The formula used in Example 1 is shown in Table 1. The raw material was fed into a blender (Hakke 600) at 160° C. for 2 min. The procedure for feeding the raw material was that: adding a quantity of high-density polyethylene into the blender; after blending for a few seconds, adding the coupling agent 2 into the blender; and after blending for few seconds, adding the titanium carbide into the blender. The rotational speed of the blender was setting at 40 rpm. After blending for 2 minutes, the rotational speed was raised to 70 rpm. After blending for 20 minutes, the mixture in the blender was drained and thereby a conductive composition with positive temperature coefficient (PTC) behavior was formed.

The above conductive composition was loaded into a mold, wherein the top and the bottom of the mold were disposed with a Teflon cloth. The mold is a steel form with an inside thickness of 0.25 mm. First, the mold with the conductive composition was pre-pressed for 3 minutes at 50 kg/cm², 180° C. Then, the gas in the mold was exhausted and refilled for 4-5 times and then the mold was laminated for 3 minutes, at 150 kg/cm², 180° C. The laminating step was repeated 2 to 3 times and each time was continued for 3 minutes. After that, a PTC sheet was formed. Then, the PTC sheet was cut to become a square of 20×20 cm². Two metal foils were laminated on the top and bottom surfaces of the PTC sheet. The PTC sheet was first sandwiched between top and bottom metal foils, Teflon cloths, buffer layers, Teflon cloths and steel plates, respectively, all of which were disposed symmetrically on the top and bottom surfaces of the PTC sheet, thereby forming a multi-layer structure. The structure was, thereafter laminated for three minutes at 70 kg/cm² 180° C. After that, the PTC sheet was irradiated with γ-ray of Co60 at equivalent of 5 Mrad. Finally, the PTC sheet was cut to form a PTC device with 5×12 mm. Two nickel foils are respectively soldered to the top and bottom surfaces of the PTC device in the longitudinal direction to act as an electrode thereof.. The resistance of the PTC device was measured by a micro-ohmmeter, the measured result is shown in Table 1.

### Example 2

The process for forming the device was the same as Example 1. However, the volume percentage of the coupling agent 2 was increased to 0.5%. The component of the conductive composition and the electric property are shown in Table 1.

### Example 3

The process for forming the device was the same as Example 2. However, the coupling agent 2 was changed to become a coupling agent 3. The component of the conductive composition and the electric property are shown in Table 1.

### Example 4

The process for forming the device was the same as Example 2. However, the coupling agent 2 was changed to become a coupling agent 1, and the feeding and blending temperature were raised to 200° C. The component of the conductive composition and the electric property are shown in Table 1.

### Comparative Example 1

The process for forming the device was the same as Example 1. However, there was no coupling agent. The component of the conductive composition and the electric property are shown in Table 1.

TABLE 1

| | | | | | | Comparative |
|---|---|---|---|---|---|---|
| | | Examples | | | | example |
| Component⁽¹⁾ | | 1 | 2 | 3 | 4 | 1 |
| Polyethylene | | 49.75 | 49.50 | 49.50 | 49.50 | 50 |
| Titanium carbide | | 50 | 50 | 50 | 50 | 50 |
| Coupling agent 1 | | — | — | — | 0.5 | — |
| Coupling agent 2 | | 0.25 | 0.50 | — | — | — |
| Coupling agent 3 | | — | — | 0.50 | — | — |
| Electric properties | | | | | | |
| 1. | Rmin | 2.97 | 1.56 | 2.4 | 1.8 | 1.7 |
| | (mΩ) (2) | | | | | |
| 2. | R1max | 13.58 | 10.7 | 12.4 | 12.52 | 22 (peel) |
| | (mΩ) (3) | | | | | |
| 3. | R1max/Rmin | 4.57 | 6.86 | 5.17 | 6.98 | 12.94 |
| 4. | Cycle life (4) | 220 | 75 | 130 | 256 | peel |
| | R300/R1 | | | | | |
| 5. | Endurance (5) | 2.17 | 1.09 | 1.93 | 1.56 | peel |
| | R48/R0 | | | | | |

note:
⁽¹⁾All components were represented by volume percentage (vol %) °
(2) The resistance of the device measured at its normal temperature (m Ω) °
(3) The resistance (mΩ) measured after one hour of soldering the nickel foil at the furnace.
(4) The ratio of the resistance measured after three hundred on-off cycles to the resistance measured after first on-off cycle. Each on-off cycle is tested under 18V/100A with duration of 10 seconds of power on and 60 seconds of power off.
(5) The ratio of the resistance measured after operating for 48 hours under power on condition (voltage/current: 18V/100A) to the initial resistance.

As shown in Table 1, after soldering at high temperature (200 to 330° C. for 8 minutes), the PTC conductive composition of the PTC device formed by the Comparative Example 1 peels off from the metal foil; however, the PTC device formed by Example 1-4 does not. Moreover, in Example 1-4, the cycle life of Example 2 is more stable (R300/R1) than others and that electric property are similar.

As shown in Table 1, the coupling agent of the conductive composition of the present invention can enhance the adhesion of the polymer, conductive filler and the electrodes, so that the reproductivity of the resistance is improved. Moreover, the PTC device formed by applying the conductive composition of the present invention has not only a lower resistance but also a longer endurance.

The methods and features of this invention have been sufficiently described in the above examples and descriptions. It should be understood that any modifications or changes without departing from the spirits of the invention are intended to be covered in the protection scopes of the invention.

What is claimed is:

1. A conductive composition exhibiting PTC behavior, comprising:
(a) at least one polymer;
(b) at least one conductive filler dispersed in the polymer; and
(c) a coupling agent having a structure as follows: 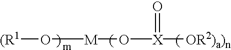
wherein M represents a metal atom or a silicon; R¹ and R² represent a substituted or unsubstituted alkyl group; X represents a sulfur or a phosphorous; a, m and n represent integers of 0 to 2.

2. The conductive composition of claim 1, wherein the polymer is selected from the group consisting of epoxy resin, polyethylene, polypropylene, polyoctylene and its copolymer or the mixture thereof.

3. The conductive composition of claim 1, wherein the conductive filler is selected from carbon black, metal or ceramic.

4. The conductive composition of claim 1, wherein the conductive filler is selected from the group consisting of carbon black, nickel, silver, gold, graphite, titanium carbide, tungsten carbide and the mixture thereof.

5. The conductive composition of claim 1, wherein the conductive filler is in a grain, flake, fiber or powder form.

6. The conductive composition of claim 1, wherein the parameter M of the coupling agent is selected from the group consisting of titanium, zirconium, molybdenum, platinum, silicon, palladium and nickel.

7. The conductive composition of claim 1, wherein the coupling agent is preferably a complex of titanium or zirconium.

8. The conductive composition of claim 1, wherein the volume percentage of the coupling agent is from approximately 0.05% through 5%.

9. The conductive composition of claim 1, wherein the volume percentage of the coupling agent is preferably from approximately 0.1% through 1%.
